(19) United States
(12) Patent Application Publication
(10) Pub. No.: US 2023/0241817 A1
(43) Pub. Date: Aug. 3, 2023

(54) SELF-LOCATING, NET-SIZED INJECTED FOAM CORE MANUFACTURING PROCESS

(71) Applicant: Mission Critical Composites, LLC, Huntington Beach, CA (US)

(72) Inventor: Thomas William STROMGREN, Huntington Beach, CA (US)

(21) Appl. No.: 18/083,444

(22) Filed: Dec. 16, 2022

Related U.S. Application Data
(60) Provisional application No. 63/290,564, filed on Dec. 16, 2021.
(60) Provisional application No. 63/295,458, filed on Dec. 30, 2021.

(51) Int. Cl. B29C 45/16; C09J 7/26; B29C 45/14

(52) U.S. Cl. CPC B29C 45/1615; C09J 7/26; B29C 45/14073; B29C 2045/14147; B29C 2045/14114; B29K 2105/04

(57) ABSTRACT

Method and tools for manufacturing core foam sections for a propeller is disclosed. In an embodiment, a method comprises wrapping a first adhesive film around pre-drilled rods; placing the rods into a first mold using placement features; injecting a high density material into the first mold and around the rods; curing the high density material to form a first cured component; removing the first cured component from the first mold; placing a second film adhesive onto the first cured component; placing the first cured component into a second mold; closing the second mold; injecting a low density material into the second mold; curing the second density material to form a second cured component, wherein the first and second cured components are bonded together.

### RELATED APPLICATIONS

This application claims the benefit of priority under 35 USC 119(e) to Provisional Patent Application Ser. No. 63/295,458, entitled “SELF-LOCATING, NET-SIZED INJECTED FOAM CORE MANUFACTURING PROCESS”, filed Dec. 30, 2021 and to Provisional Patent Application No. 63/290564, entitled “SELF-LOCATING, NET-SIZED INJECTED FOAM CORE MANUFACTURING PROCESS”, filed Dec. 16, 2021. All of the above are incorporated by reference in their entirety as if set forth in full.

### BACKGROUND

### Field of the Invention

The embodiments described herein are generally directed to manufacturing using composite material, and more particularly, to composite material manufacturing processes that use rigid foam materials.

### Description of the Related Art

A conventional process for machining, e.g., Rohacell® foam core sections for, e.g., a lift propeller that is bonded with other sections later in the process. First, the lift propeller center hub can be machined via the following steps: machine one face of the first block of high density foam flat for the upper half center Hub; flip the first block of foam over and machine the upper half center hub to the required shape and profile; machine one face of a second block of high density foam flat for the lower half center hub; and flip the second block of foam over and machine the lower half center hub to the required shape and profile.

Then the lift propeller blades are manufacture using the following steps: machine one face of each of two low density foam blocks flat for the lower half of the lift propeller blade; flip one block of foam over and machine the foam to the required shape and profile of the right hand lower half propeller blade; flip the second block of foam over and machine the foam to the required shape and profile of the left hand lower half propeller blade; machine one face of each of the (2) low density Rohacell foam blocks flat for the upper half of the lift propeller blade; flip one block of foam over and machine the foam to the required shape and profile of the right hand upper half propeller blade; and flip the second block of foam over and machine the foam to the required shape and profile of the left hand upper half propeller blade.

But for each lift propeller there are six individual foam sections that must be machined for just one lift propeller: two halves of machined foam for one center hub; and four halves of machined foam for one lift propeller blade. Total machining steps involved: A minimum of forty steps for twenty four individual pieces. There are also additional time and materials needed to bond the twenty four pieces together to make four complete foam cores for four lift propellers.

The conventional ply cutting method for a layup of, e.g. a lift propeller is to extract the ply definition from the model into CutWorks (or similar), create a Virtek laser program for ply placement, Gerber cut the ply patterns one by one from the designated material, collect the patterns into a kit, and forward the kit to the lamination technician. The technician would place each pattern into the layup mold, positioning each pattern within the boundaries generated by the Virtek Laser ply positioning program. This method can be used for small quantities, but is not recommended for long term production where the quantities needed start in the hundreds and increase to quantities of thousands for the following reasons: ply-by-ply hand layup of each lift propeller will require a very large amount of “touch labor” hours; the hand layup process will require some degree of training for each laminating technician, to ensure each lift propeller is laid up correctly; there is a risk of placement error for each ply by the lamination technician; the ply-by-ply hand layup process is not fast enough to support large scale production quantities; and the ply-by-ply hand layup process is not easily able to be scaled up.

Moreover, in conventional processes, the layup surface of a tool must be extremely smooth, maintain vacuum integrity and withstand the environment of an autoclave. Tools made from foam will require many, many man-hours of trying to seal the open cells of foam to create a smooth surface to lay up material on. This will require surface filling, sanding, re-filling, re-sanding, etc., which will alter the original profile machined into the foam. There is a very high probability the resultant part will be inaccurate and un-useful for any developmental purposes or for production of, e.g., lift propellers. Also, foam tools are inherently impossible to seal and maintain vacuum integrity with any degree of success. Finally, foam tools are not capable of withstanding an autoclave environment for long term use.

### SUMMARY

Accordingly, systems, methods, and non-transitory computer-readable media are disclosed to self-locating, net-sized injected foam core manufacturing process.

The method may be embodied in executable software modules of a processor-based system, such as a server, and/or in executable instructions stored in a non-transitory computer-readable medium.

### BRIEF DESCRIPTION OF THE DRAWINGS

Other objectives of the disclosure will become apparent to those skilled in the art once the invention has been shown and described. The manner in which these objectives and other desirable characteristics can be obtained is explained in the following description and attached figures in which:

FIG. 1 shows an automated tape laying machine (ATL), according to an embodiment;

FIG. 2 shows upper and lower propeller skins, according to an embodiment;

FIG. 3 shows a foam core shape, according to an exemplary embodiment;

FIG. 4 shows a foam core insert, according to an exemplary embodiment;

FIG. 5 shows a foam injection mold, according to an exemplary embodiment;

FIG. 6 shows a foam injection mold, according to an exemplary embodiment;

FIG. 7-9 show a high density foam mold during a process of manufacturing a foam core, according to an exemplary embodiment;

FIG. 10 shows a complete high density foam hub insert, according to an exemplary embodiment;

FIGS. 11a-11b show a high density foam hub, according to an exemplary embodiment;

FIG. 12 shows low density foam injected into a low density foam mold, according to an exemplary embodiment; and

FIG. 13 shows a foam core manufactured according to an exemplary embodiment.

### DETAILED DESCRIPTION

After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

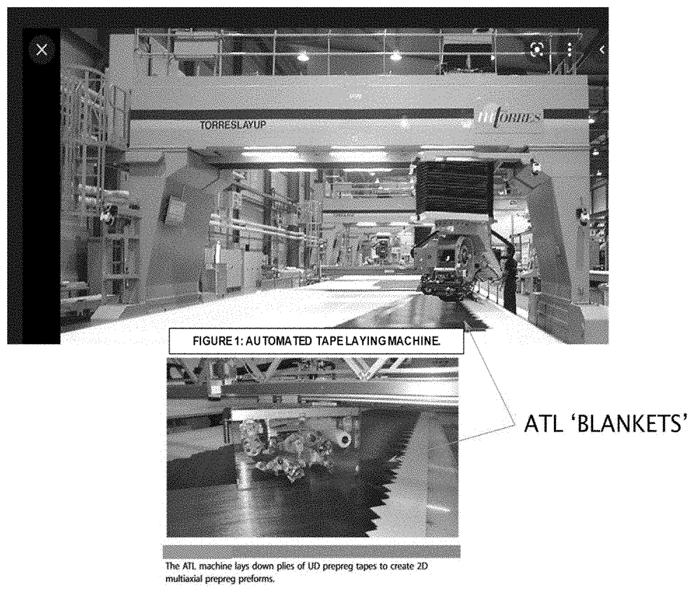

The goal of the process for ply pattern cutting described herein is to automate the process as much as possible. The method of automation is Automated Tape Laying (ATL). This method uses a Computer Numberical Control (CNC) machine to lay down successive layers of prepreg material in any angle and under pressure to form a large ‘blanket’ consisting of the layers and fiber orientation dictated by Model Based Definition (MBD) (See FIG. 1). Angle, pressure, temperature etc., are pre-programmed into the machine per MBD requirements. When the ‘blanket’ is complete, the ATL machine can cut out multiple patterns of the peripheral shape of the lift propeller skin laminate, creating “charges”. The ‘charge’ is then placed and located into the layup mold for continued processing and curing. The benefits of the ATL for HRP (High-Rate Production) are: the ATL process significantly reduces the amount of “touch labor” hours per layup technician, per lift propeller; the amount of training required per layup technician to install a ‘charge’ into the layup mold is much less than the training needed for ply-by-ply layup of the same part; the risk of ply placement error is greatly reduced. Example: The probability of incorrectly placing 1-2 ‘charges’ per mold is much lower than the probability of incorrect placement of the 40 individual plies that make up the same ‘charge’, the ATL process can support production quantities; the ATL process can be scaled up to support more quantities; the ATL process is robust and programmable; the ATL process is accurate and repeatable; the ATL process is also measurable; the ATL process can support both fabric and unidirectional materials; the ATL process optimizes material usage more efficiently; the ATL process significantly reduces the probability and risk of FOD (Such aats prepreg paper backings and/or polyfilms) being introduced into the laminate.

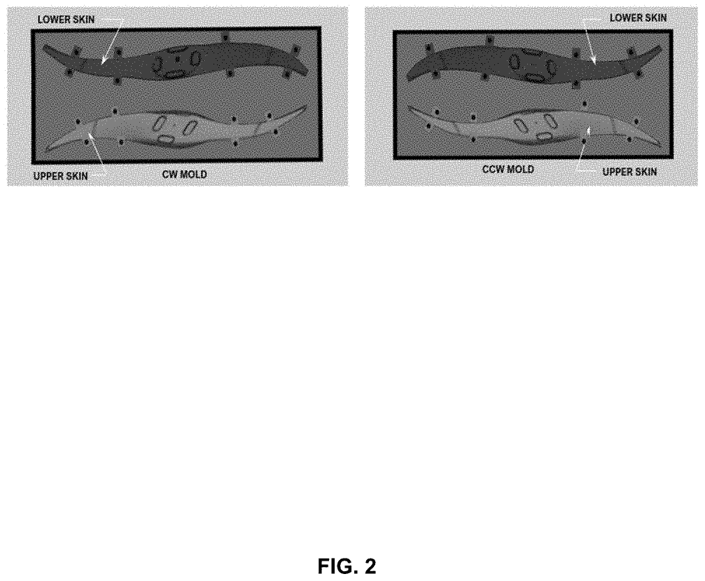

The described layup tooling method consists of (2) layup tools. One layup tool for the clockwise (CW) propeller skins and one tool for the counterclockwise (CCW) propeller skins. Each tool will lay up and cure a complete set of Upper and Lower Propeller Skins as shown below. (See FIG. 2). Multiple Layup tools of each propeller type will be utilized and ‘batch cured’ in an autoclave.

The layup tools are manufactured as a hybrid, consisting of a carbon fiber/epoxy resin Facesheet for the layup surface which is supported and attached to an Invar 36 support structure of an ‘egg-crate’ type design. The benefits of this type of tooling are: the layup molds can support production; the layup molds can be scaled up to support more quantities; the layup molds are robust; the entire carbon fiber layup surface can be easily removed if needed, a new layup surface installed on the existing Invar 36 support structure and machined to profile again, which negates the necessity of needing to rebuild the entire tool should major damage to the tool surface occur; the layup molds are dimensionally very accurate with almost zero CTE even at elevated autoclave cure temperatures; the layup molds have a life cycle of approx. 500-1000 parts if tools are well maintained; the layup molds can support both fabric and unidirectional materials. Layup surface profiles can be reconfigured faster, less down time and much reduced cost than a standard, all metallic tool.

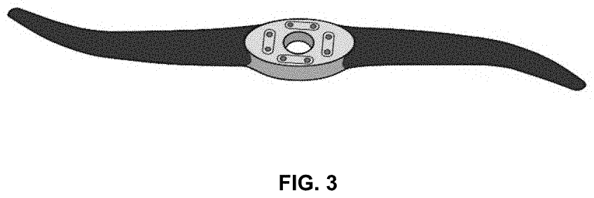

The method of foam core fabrication described below eliminates the machining process, eliminates the syntactic core propeller tips, is self-locating, and will consistently and repeatedly produce a dimensionally accurate foam core shape, with a consistent density and weight, and can integrate the bonding of ‘pre-drilled’ Gil rods (See FIG. 3). The process of secondarily bonding, e.g., Gil rods into the foam core with a paste adhesive is also eliminated.

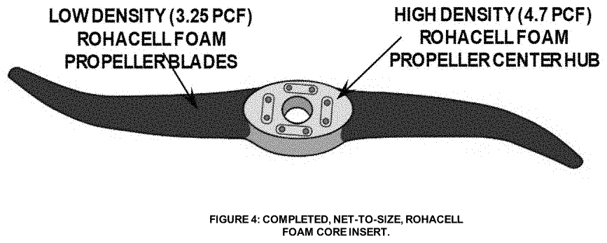

The method uses a split, ‘clam-shell’ tool design, with the foam being injected into the mold. The Gil rods are pre-wrapped with a film adhesive and securely pre-positioned inside the mold. The inside surface of the mold also has the same profile as the ply drops, steps and overlap features that would be present in the IML surface of the Upper and Lower Lift Propeller skins. The injected foam will bond to the film adhesive wrapped Gil rods. (See FIG. 4). This mold will also produce the features necessary for locating the foam core to the Upper and Lower skins when placed into the into the bonding mold. There will be (1) CW Foam Core Mold and (1) CCW Foam Core Mold. The benefits of this core fabrication process are:

The core fabrication process can be utilized in general for composite propellers.

The core fabrication process can be utilized in general for composite propellers in the aviation industry, such as eVTOL aircraft, Hovercraft, and ducted propeller systems.

The core fabrication process can be utilized in general for composite propellers in the commercial industry, such as wind turbines, Airboats (Fanboats) and similar craft.

The core fabrication process can be utilized in general to incorporate many other composite materials, including, but not limited to, carbon fiber, fiberglass, film adhesives, honeycomb core, internal structural foams made polymethacrylimide (PMI), such as Rohacell) or polyvinyl chloride (PVC) based foams.

The core fabrication process can utilize varying densities of structural foams concurrently.

The core fabrication process generates no excessive material waste.

The process requires fewer manufacturing steps and decreases the time to produce a final foam core compared to a machining process.

The process eliminates the entire machining cost and time needed to produce a foam core and a Lift Propeller.

The process is robust, repeatable and measurable.

The core fabrication process reduces the risk of bond line failure since all bonding surfaces of the foam core match the features present on the Upper and Lower Propeller skins.

The foam core fabrication process can support production quantities.

The process can be scaled up to support more quantities than the schedule and quantities forecasted by Beta Technologies if needed.

The bond line thickness between the foam core and the skins will be very consistent and can be done with a film adhesive with the process.

With the process, the quantity of balancing weights a lift propeller might use will be more consistent from one propeller to the next since a known quantity of film adhesive weight is used. The weights of the other components is also known and recorded. The Process results in a Lift Propeller Foam Core Assy. The film adhesive is also known to be distributed evenly throughout the propeller. A diagram of the foam core mold for use in the process is shown on the next pages.

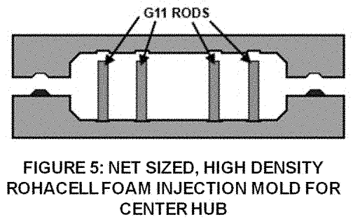

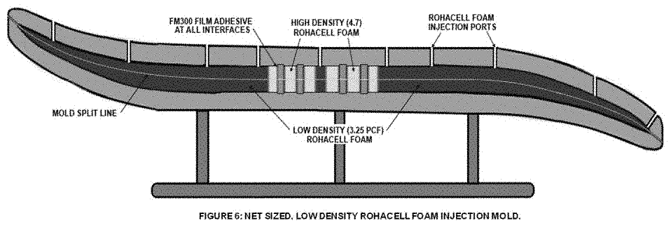

The proposed manufacturing process for foam core fabrication can also accommodate the two densities of foam required in a Lift Propeller. (See FIG. 4). How this is accomplished is shown in FIGS. 5 and 6.

The pre-drilled Gil rods are pre-wrapped with a Film Adhesive (0.02-0.041 bs/ft2/100 200 g/m2) and placed into the HDRM as shown in FIG. 5. The lower and upper halves of the mold have shallow, cylindrical pockets with buttons machined into the mold halves for exact and repeatable placement of the Gil rods. High density (4.7 PCF) Rohacell Foam is injected into the HDRFM. The Foam is cured at 338° F.-374° F. and under pressure (1.25-43.5 psi/0.05-0.3 N/mm2). This will also cure the Film Adhesive around the Gil rods. The net-to-size, high density Foam Center Hub insert is removed from the HDRFM. Film Adhesive is placed on the high-density foam insert at the locations where it will join low density Foam. The high-density foam insert is placed into the Low Density Rohacell Foam Mold (LDRFM) located. The LDRFM is closed, and low density (3.25 PCF) Rohacell Foam is injected into the LDRFM (FIG. 6).

The Foam is cured at 338° F.-374° F. and under pressure (1.25-43.5 psi/0.05-0.3 N/mm2). This will also cure the Film Adhesive between the low-density foam and the high-density foam hub insert. The net-to-size, Foam Lift Propeller insert, completely cured with the Gil rods, with both high and low density Foams, is removed from the LDRFM. The Foam Lift Propeller insert can be inspected to MBD and weighed. The Foam Lift Propeller insert can now be stored or used immediately for bonding to the propeller skins.

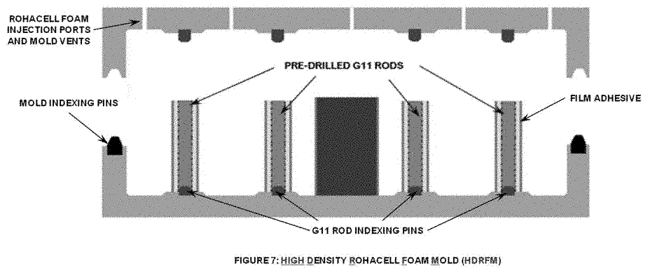

The HDRFM is a two-piece, clamshell design mold. FIG. 7 shows a cross section of the HDRFM with the pre-drilled Gil rods with film adhesive wrapped around them, and the low-density foam center with film adhesive wrapped around it. The Gil rods are located onto pins in the HDRFM. The same can be done with the low-density foam center.

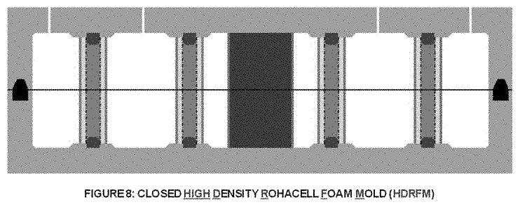

FIG. 8 shows a cross section of the closed HDRFM with the pre-drilled Gil rods and low-density foam center securely and accurately indexed into place inside the HDRFM.

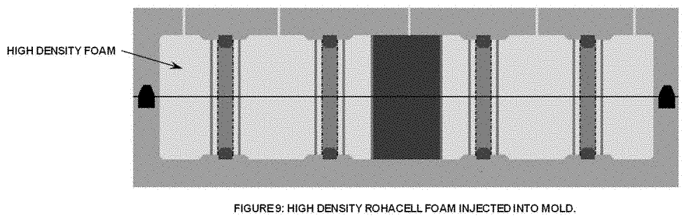

High density Foam is injected into the mold, encapsulating the Gil rods and center foam section. (See FIG. 9).

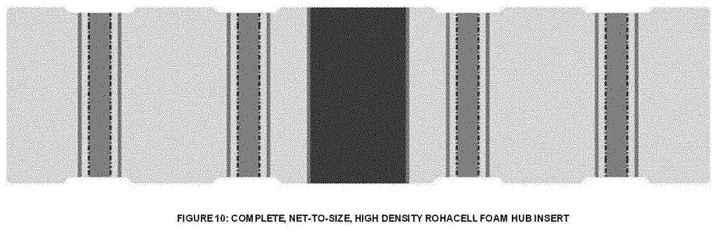

After curing, the net-to-size, high density Foam insert is removed from the HDRFM. All features are securely bonded in place. No secondary bonding with a paste adhesive is necessary and no secondary drilling of the Gil Rods with a drill jig is necessary. The High Density Rohacell Foam Lift Propeller insert can be inspected to MBD and weighed. The complete Lift Propeller hub insert can then be stored or used immediately for bonding to the Low Density Rohacell Foam. (See FIG. 10).

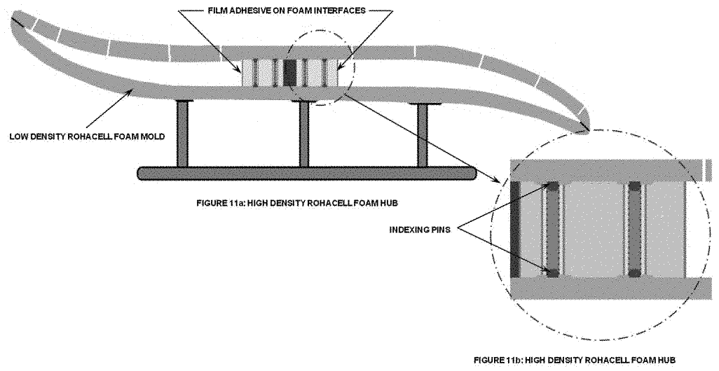

The Low-Density Rohacell Foam Mold (LDRFM) uses the same principles to mold the Low-Density Foam areas as the HDRFM does. The same indexing features and pattern used to index the Gil rods into the HDRFM are used to index the completed High Density Foam Hub into the LDRFM (See FIG. 11a and 11b).

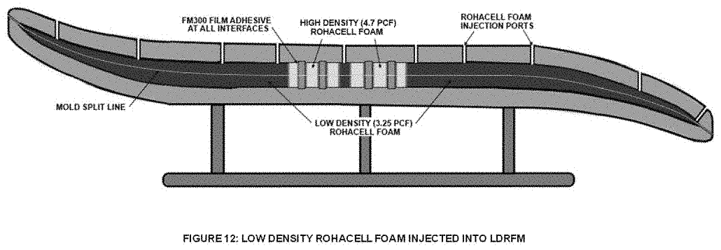

Low-Density Foam is injected into the LDRFM. The same indexing features and pattern used to index the Gil rods into the HDRFM are used to index the completed High Density Foam Hub into the LDRFM (See FIG. 12).

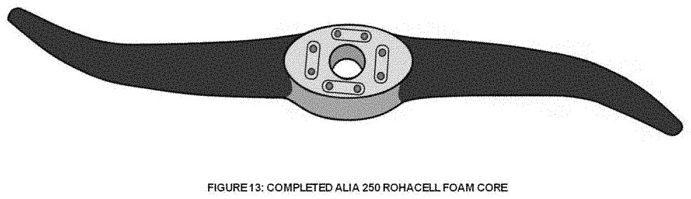

After curing, the complete, net-to-size, Lift Propeller Foam Core Assembly is removed from the LDRFM. All features are securely bonded in place. No secondary bonding with a paste adhesive is necessary and no secondary drilling of the Gil Rods with a drill jig is necessary. The High Density Foam Lift Propeller insert can be inspected to MBD and weighed. The complete Lift Propeller Foam Core insert can then be stored or used immediately for bonding to the Carbon Fiber Lift Propeller Skins (See FIG. 13).

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A method of manufacturing a composite propeller, comprising: wrapping a first adhesive film around one or more rods; placing the rods into a first mold; injecting a first density material into the first mold and around the rods; curing the first density material inside the first mold at a first temperature and a first pressure to form a first cured component.

2. The method of claim 1, wherein placing the rods into the first mold comprises using placement features of the first mold.

3. The method of claim 2, wherein the placement features comprise pins formed on the inside of the first mold; wherein the rods are pre-drilled rod having through openings; and wherein placing the rods into the first mold comprises aligning the openings with the pins.

4. The method of claim 3, wherein the first mold comprises a first half and a second half, and wherein a first portion of the pins is placed on the first half and a second portion of the pins is placed on the second half.

5. The method of claim 1, wherein curing the first density material cures the first adhesive film such that the pins are bonded to the first cured component via the first adhesive film.

6. The method of claim 1, wherein injecting the first density material comprises injecting the first density material via one or more injection ports of the first mold.

7. The method of claim 1, wherein the first mold comprises a split, clam-shell design having a top side, a second side, and at least one injection port formed in the top side of the first mold.

8. The method of claim 1, further comprising: removing the first cured component from the first mold; placing a second film adhesive onto the first cured component;
placing the first cured component into a second mold; closing the second mold;
injecting a second density material into the second mold; curing the second density material at a second temperature and a second pressure to form a second cured component.

9. The method of claim 8, wherein curing the second density material cures the second film adhesive such the first cured component is bonded to the second cured component via the second adhesive.

10. The method of claim 8, wherein the first density material is a higher density material than the second density material.

11. The method of claim 8, wherein the first density material and the second density material are a high density foam and a low density foam, respectively.

12. The method of claim 8, wherein placing the first cured component into the second mold comprises using the rods within the first cured component to position the first cured component in the second mold.

13. The method of claim 12, wherein the second mold includes comprise second pins formed on the inside of the second mold, wherein the first pins and the second pins are formed in the same arrangement.
